(19) United States
(12) Patent Application Publication
(10) Pub. No.: US 2008/0140722 A1
(43) Pub. Date: Jun. 12, 2008

(54) INTERACTIVE VIEWING, ASYNCHRONOUS RETRIEVAL, AND ANNOTATION OF MEDICAL IMAGES

(75) Inventor: Rex Jakobovits, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: VIVALOG LLC, Seattle, WA (US)

(21) Appl. No.: 11/943,388

(22) Filed: Nov. 20, 2007

Related U.S. Application Data
(60) Provisional application No. 60/860,045, filed on Nov. 20, 2006.
(60) Provisional application No. 60/860,122, filed on Nov. 20, 2006.

(51) Int. Cl. G06F 17/30

(52) U.S. Cl. 707/104.1; 707/E17.019

(57) ABSTRACT

Methods, apparatuses, and articles for interactive viewing, asynchronously retrieving and annotating medical images are described herein. In various embodiments, a client device may retrieve, from a server, a network resource having medical information and associated medical images, with the server initially including only a subset of the medical images. The client device may then facilitate a user in interactive viewing of the retrieved medical images, and asynchronously retrieve additional ones of the medical images from the server as the retrieved medical images are being interactively viewed. In some embodiments, in response to interactive viewing, the client device may request of a server a graphical primitive, the request specifying a graphical primitive type and information associated with the interactive viewing. In response the client device may receive the primitive and may create an annotation layer including the primitive associated with the medical image.

### RELATED APPLICATIONS

The present non-provisional application claims priority to provisional application No. 60/860,045, entitled “Methods and Systems to Manage, View, Manipulate, Share, and Annotate Images in a Web Browser”, filed Nov. 20, 2006, and to provisional application No. 60/860,122, entitled “Methods and Systems to Accommodate Decision Support and Reference Case Management for Diagnostic Imaging”, filed Nov. 20, 2006.

### FIELD OF THE INVENTION

Embodiments of the invention relate to medical imaging and client-side image management. More specifically, embodiments of the invention relate to interactive viewing, asynchronously retrieving, and annotating of medical images in a generic viewing agent, such as a web browser.

### BACKGROUND

Advances in processor, networking and other related technologies have led to increased adoption of client-server computing, including for the viewing of medical images, typically using specially developed medical related software, due in part to their complexity.

Beyond medical images, abundant amounts of multi-media content are now available on private and public networks. Today managing, viewing, manipulating, sharing and annotating medical images may be performed via a generic viewing agent such as a web browser, but often requires usage of separate software component, and/or installation of special add-on or plug-in software to the web browser, such as Applets or ActiveX technology. In many environments, including many environments where medical images are viewed, it is often not convenient to load Applets or ActiveX components that are not already installed in the browser, due to security constraints, performance issues, and/or managed deployment constraints.

### SUMMARY

Embodiments of the invention described herein provide a general solution that leverages on markup and scripting languages, such as data representation language (e.g., HTML), near-ubiquitous client-side scripting languages (e.g., JavaScript), and locally available graphics/animation services (e.g., Flash) for interactive viewing, asynchronously retrieving, and annotating of medically related images over a networking fabric (e.g., the Internet) and communicating with a medical image server. Embodiments of the invention may rely on a technique known as “Asynchronous JavaScript and XML” (hereinafter “Ajax”) to manipulate medical images with the browser and communicate with the medical image server asynchronously.

Embodiments of the invention further may enable users of client devices to retrieve medical images from a server, view annotations, adjust medical image properties such as brightness and contrast, navigate up and down through a stack of medical images, zoom in and pan around on medical images, draw annotation layers on the medical images, and save annotations back to the medical image server. Medical images may be dynamically resized to fit the resolution of the viewing window, and higher resolution images may automatically retrieved from the server when the medical image is enlarged. These types of features rely on user interface functionality that is not usually found in non-medical web applications, e.g. instantaneous updates to a current web page without requiring a browser refresh.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a first flowchart view of selected client device operations, in accordance with various embodiments;

FIG. 3 illustrates a second flowchart view of selected client device operations, in accordance with various embodiments;

FIG. 4 illustrates an exemplary screen shot of a case viewer with image viewer on the right;

FIG. 5 illustrates an exemplary screen shot of an annotation interface;

FIG. 6 illustrates an exemplary screen shot of a stack viewer; and

FIG. 7 illustrates an example computing system suitable for practicing all or selected aspects of the embodiments of the invention.

### DETAILED DESCRIPTION OF EMBODIMENTS OF THE INVENTION

Illustrative embodiments of the present invention include, but are not limited to, methods and apparatuses for interactive viewing, asynchronously retrieving, and annotating medical images, using client-side logic (such as AJAX) and/or locally available graphics/animation services (such as Flash), but not requiring additional ActiveX components or Java applets, and hence, being able to run in the majority of browsers without requiring the changing of security settings or the installation of new software components. In various embodiments, a client device may retrieve, from a medical image server, a network resource having medical information and associated medical images, with the medical image server initially including only a subset of the medical images. The client device may then facilitate a user in interactive viewing of the retrieved medical images, and asynchronously retrieve additional ones of the medical images from the server as the retrieved medical images are being interactively viewed. In some embodiments, in response to interactive viewing, the client device may request of a server a graphical primitive, the request specifying a graphical primitive type and information associated with the interactive viewing. In response the client device may receive the primitive and may create an annotation layer including the primitive.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

As used herein, the term “interactive viewing” means viewing, managing, and/or annotating a retrieved medical image and/or medical information through, for example, user interactions. Such user interactions may include, for example, brightness or contrast adjustments, navigation between retrieved images, zooming or panning actions, drawing annotations on one of the retrieved images, or saving the annotations.

Further, for the remaining descriptions, the terms “image” and “medical image”, in singular or plural form, will be used interchangeably. Unless the context clearly indicates otherwise, the two terms are to be read as synonyms of each other. Also, as used herein, the phrase “locally-available graphics/animation services” refers to general, commonly deployed services, such as Flash, and not to specific-purpose services that a user might be asked to deploy specifically for a medical image application, such as a specific-purpose ActiveX component.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A, B, or (A and B)”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

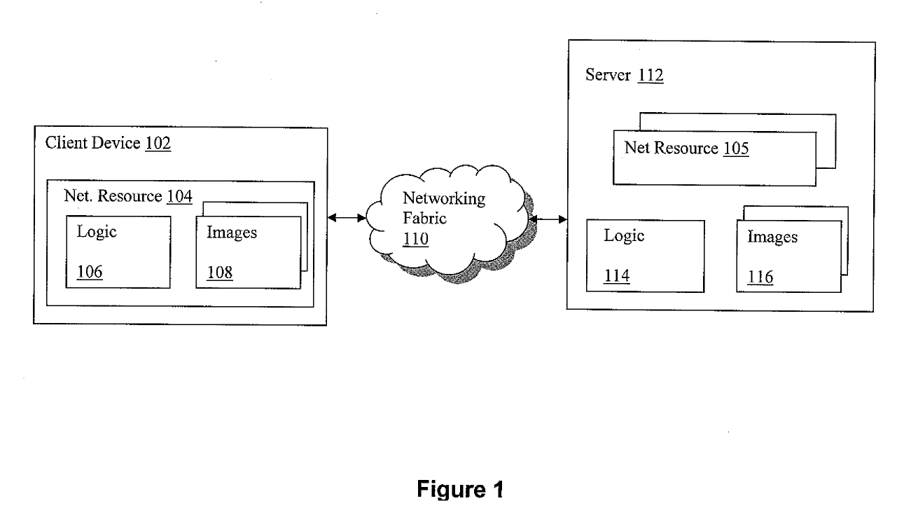

FIG. 1 illustrates an overview of various embodiments of the present invention. As illustrated, a client device 102 may be communicatively coupled to a server 112 via a networking fabric 110, and may retrieve a network resource 104 from server 112 over networking fabric 110. Network resource 104 may be one of a plurality of network resources 105 associated or stored with server 112. Each network resource 105 may include medical information and one or more associated medical images 116. As illustrated, network resource 104 may be initially as well as subsequently provided with only a subset of the associated medical images 116 (hereinafter “images 108”). As will be described in more detail, network resource 104 may further include logic 106 to facilitate interactive viewing of the images 108 by a user of client device 102, as well as asynchronously retrieving additional ones of the associated medical images 116, thereby improving delivery efficiency and user viewing experience. In other embodiments, client device 102 may additionally or alternatively comprise locally available graphics/animation services, such as a Flash Player (not shown), to facilitate the interactive viewing and asynchronous retrieval. Server 112 may have network resources 105 (including 104) and the full set of associated medical images 116 (hereinafter “images 116”), and logic 114. As described earlier, server 112 may provide client device 102 with network resource 104 and initially a subset of the associated images 108. Logic 114 may be configured to select initial images 108 from images 116, and to handle asynchronous requests from and responses to client device 102 for additional images. In some embodiments, as images 108 are being interactively viewed, client device 102, through logic 106 and/or locally available graphics/animation services, may asynchronously retrieve additional ones of images 116 from server 112.

In some embodiments, in response to interactive viewing, client device 102 may further request from server 112 a graphical primitive, the request specifying a graphical primitive type and information associated with the interactive viewing. In response client device 102 may receive the primitive and may create an annotation layer including the primitive.

As mentioned, in various embodiments, client device 102 and server 112 may be communicatively coupled by networking fabric 110. Such a networking fabric 110 may be any known in the art, such as a LAN, a WAN (public or private), and/or the Internet, and may be either partially or entirely wired and/or wireless.

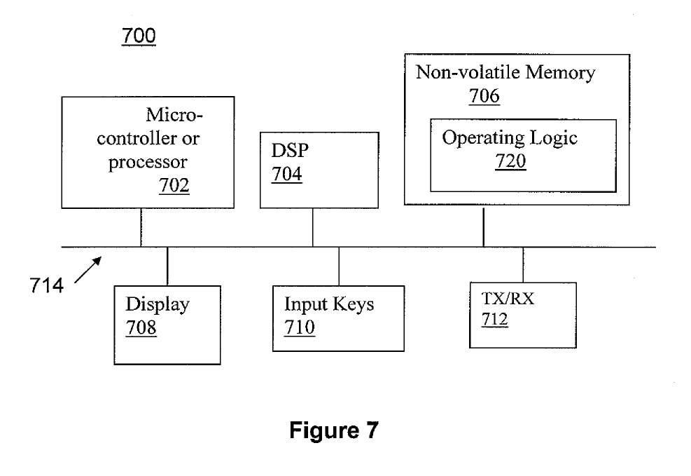

In various embodiments, client device 102 and/or server 112 may each be one or more of any sort of computing device known in the art, except for network resource 104, logic 106, images 108, logic 114, images 116, and other logic and data adapted to perform the operations described more fully herein. Client device 102 and/or server 112 may each be a personal computer (PC), a workstation, a server, a router, a mainframe, a modular computer within a blade server or high-density server, a personal digital assistant (PDA), an entertainment center, a set-top box or a mobile device. Further, client device 102 and/or server 112 may each be any single- or multi-processor or processor core central processing unit (CPU) computing system known in the art, except for network resource 104, logic 106, images 108, logic 114, images 116, and other logic and data adapted to perform the operations described more fully herein. An exemplary single-/multi-processor or processor core user client device 102 and/or server 112 is illustrated by FIG. 7, and will be described in greater detail below.

In various embodiments, network resource 104 may be a web page or any other sort of content provided over a network, such as the Internet. In one embodiment, client device 102 may include a web browser (not shown), such as any browser known in the art, to manifest network resource 104 having medical information and to, along with logic 106, facilitate a user of client device 102 in interactive viewing associated medical images 108 that may be incrementally and/or asynchronously retrieved. In the same or other embodiments, client device 102 may further include locally available graphics/animation services (not shown), such as a Flash Player, which may be integrated with a web browser to manifest network resource 104 and to facilitate interactive viewing. In such embodiments, logic 106, such as ActiveScript logic, may be configured to be interpreted by the graphics/animation services. As mentioned above, network resource 104 may include may include medical information, and the medical information may comprise textual, graphic, video, and/or audio information. Such information may be related to a single case, a series of cases, a diagnosis, or any other medically related topic. For example, as illustrated by FIG. 4 and described below, the medical information may comprise Findings with regard to a case, the findings describing, in part, images 108/116.

As further mentioned, each of network resources 105 (including 104) may have one or more associated images 116 (108, in the case of 104), which may be of any image format, such as the JPEG format, and logic 106. In some embodiments, network resources 105 (including 104) may be comprised of Hypertext Markup Language (“HTML”) segments, Extensible Markup Language (“XML”) segments, and/or JavaScript segments, the JavaScript language segments comprising at least partially logic 106. In one embodiment, logic 106 of network resources 105 (including 104) may enable a browser of client device 102 to asynchronously retrieve additional ones of images 116 and/or other contents through use of a technique known as Asynchronous JavaScript and XML (“AJAX”). In other embodiments, as mentioned above, logic 106 may also or instead comprises segments configured to be interpreted by graphics/animation services of client device 102. Such segments may be ActiveScript segments.

In some embodiments, server 112 may be a web server offering network resource 105 (including 104) over networking fabric 110. Thus, server 112 may store network resources 105 (including 104) and, in various embodiments, a plurality of other network resources for client device 102 and/or other client devices.

In various embodiments, as mentioned above, images 108 downloaded onto client device 102 initially, and/or subsequently at any one point in time, may comprise a subset of images 116. In various embodiments, images 116 may have been transcoded from externally provided images by logic 114 for efficient transfer over networking fabric 110, the transcoded images 108/116 having a first image format, such as a JPEG format of a first bit rate lower than a second bit rate of a second image format, such as a DICOM format, of the externally provided images. In some embodiments, server 112 may receive the externally provided images from one or more medical devices, such as a CT scan device. Server 112 may select a subset of the transcoded images 116, as a default set, and provide the transcoded subset as images 108 to client device 102. In one embodiment, the transcoded subset of images 108 may be organized as a stack and provided as a stack to client device 102. In some embodiments, images 108 may be an expandable set, with additional ones of images 116 provided on demand in response to a user interaction on the client device 102. For example, if a user of client device 102 scrolling through the stack of images 108, logic 106 and/or locally available graphics/animation services may at a predetermined threshold asynchronously request for additional ones of images 116. By asynchronously requesting for additional images at predetermined threshold, logic 106 is able to anticipate user needs prior to future user interactions.

In some embodiments, as mentioned above, logic 106 may be at least partially JavaScript segments and/or ActiveScript segments of network resource 104. Such logic 106 may be interpreted by a JavaScript-enabled browser of client device 102 or locally available graphics/animation services of client device 102, in various embodiments, to facilitate interactive viewing of the images 108 and to asynchronously retrieve additional ones of images 116 and/or other content. Logic 106 may also be interpreted by a browser to perform other operations described below. In some embodiments, the interactive viewing facilitated by logic 106 may include a user interaction, and the user interaction may be one of a brightness or contrast adjustment, navigation between images of the subset of images, a zooming or panning action, drawing annotations on one of the subset of images, or saving the annotations. Also, the asynchronous retrieving by logic 106 may be in response to such a user interaction, and the additional ones of the images retrieved may be selected by the server based on the user interaction. For example, logic 106 may perform asynchronous retrieving by making an asynchronous request of server 112 and including at least a parameter, the parameter indicating the user interaction.

In various embodiments, logic 106 may also facilitate a user interaction with a visually manifested image 108 of network resource 104. Client device 102 may then receive a user interaction. In response to receiving the user interaction, logic 106 and/or locally available graphics/animation services may asynchronously request from server 112 a graphical primitive, the request specifying a graphical primitive type and information associated with the received user interaction. In one embodiment, the graphical primitive may be a draggable, scalable image and the network resource is a web page. The graphical primitive type may be one of a text type, a circle type, a box type, and a line type. In some embodiments, client device 102 may then receive the graphical primitive. In response to receiving the graphical primitive, logic 106 and/or locally available graphics/animation services may create an annotation layer including the graphical primitive.

In some embodiments, logic 114 may be coded in any sort of programming language known in the art, such as Java, C++, JavaSever Pages, and Active Server Pages. Logic 114 may be compiled instructions executed as a single- or multi-threaded process, or may be an interpreted script executed by, for example, a runtime environment. Logic 114 may access one or more databases (not shown) containing, for example, images 116 and network resource 104. As described above, logic 114 may provide to client device 102 a network resource 104 having medical information and initially (or at any one point in time) images 108. As further mentioned, prior to providing images 108, logic 114 may accumulate images 116, including generating them by transcoding externally provided images of higher bit rate to lower bit rate images. In response to receiving by server 112 an asynchronous request for additional ones of images 116, the request including at least one parameter associated with the interactive viewing, logic 114 may provide the additional ones of images 116 to client device 102. In one embodiment, logic 114 may select the additional ones of the images 116 in view of the parameter.

In various embodiments, as discussed briefly above, Ajax and Flash techniques may be leveraged by logic 106 to provide a richer user experience without relying on Applets and ActiveX technology to break out of the limitations normally associated with web-based apps. For example, using these techniques, logic 106 may enable users to draw annotations, or zoom in and pan around on images, user interface functionality normally associated with desktop applications or java programs. Images may be dynamically resized to fit the resolution of the viewing window, and higher resolution images may be automatically retrieved from the server when the image is enlarged. These types of features may rely on user interface functionality that is not usually found in pure web applications, e.g. drag and drop, dynamic image manipulation, and instantaneous updates to the current web page without requiring a browser refresh. To circumvent these limitations in web-based software, vendors have traditionally relied Java applets or ActiveX components. However, both of these technologies have major drawbacks. Java applets suffer from slow downloads, poor performance, and require the bulky java environment be installed on every client machine. ActiveX components are limited to Internet Explorer on a Windows PC and do not support alternative browsers such as Firefox, or platforms such as the Apple Macintosh. Furthermore, ActiveX components represent a security compromise, and many hospitals disallow them on diagnostic workstations.

In various embodiments, logic 106 may facilitate image zooming and panning. Viewed through a statically sized (but independently resizable) viewport, an image 108 can be magnified or de-magnified and repositioned by drag-and-drop, button and/or key press events. An IFRAME element of network resource 104 can be used as a viewport, wherein an image 108 is the significant element within that window. Using a drag-and-drop toolkit (such as Yahoo's YUI), the image 108 can be moved around within the window, but it is automatically clipped by a client device 102 browser to the dimensions of that IFRAME. The image 108 can be magnified via JavaScript (e.g., logic 106) by adjusting the width and height proportionally in relation to the original dimensions of the image 108. The drag operation can be nullified if the destination of the image 108 would place any of its boundaries within the boundaries of the viewport, thereby constraining the drag operation to display only the image 108 contents within the viewport (and not any margins outside the image). The image 108 in the browser can be larger than the size being displayed, and the browser will reduce it to the dimensions desired by the user, without any noticeable degradation of quality. Then when the user enlarges or zooms in on the image 108, it can be immediately displayed larger without having to retrieve a larger image from the server 112, until a threshold is crossed.

In some embodiments, the above-described interactive viewing may comprise magnifying one of images 108 beyond a predefined or dynamically calculated contextually-based threshold, such as the image's native dimensions, the one of images 108 having a first resolution. Logic 106 may then replace the one of images 108 with another image having a second resolution, the first resolution being lower than the second resolution. Logic 106 may perform the replacing by asynchronously requesting the other image from server 112. The replacing may also comprise substituting, by logic 106 the original image 108 in situ with the higher-resolution other image, the other image being a rendering of the same image. The replacing can be accomplished either ad hoc, by means of either a pre-existing URL, or an AJAX (IFRAME or XmlHttpRequest) request to a URL-based web service (such as logic 114) that supplies the URL for the replacement image, optionally creating the image at that URL on-demand. Images 116 can be blown up beyond their native resolution on the server 112 by logic 114, using interpolation to smooth the images so they do not appear pixilated. The larger image may then be sent to the client device 102 on demand when a threshold is crossed. The larger image may then be shrunk down to fit the dimensions that the user desires by logic 106.

In various embodiments, images 108 may comprises a collection of images 108, the collection being visually manifested to the user as a set of thumbnail images, the interactive viewing may comprise facilitating the user in browsing to a second collection of images corresponding to additional ones of images 116, and the asynchronous retrieving may comprises retrieving the second collection. In one embodiment, images 108 can be grouped into collections by the user submitting them. Thumbnails representing the images 108 may appear in one pane, with the full size selected image 108 appearing in another pane (see FIG. 4 for an exemplary illustration). The full size image 104 may resize to fit the size of the pane whenever a new thumbnail is pressed. A user can visit a next collection using a collection navigator provided by logic 106, and the new collection may be loaded into the viewer asynchronously by logic 106 using AJAX techniques without having to reload the network resource 104.

In some embodiments, the above-described interactive viewing may comprise resizing, by the user, a window containing one of images 108, and the one of images 108 may be dynamically resized to fit the resized window dimensions by logic 106. Thus, an object (e.g. image 108) may be dynamically resized to the size of its container (e.g. window) when that container is itself resized. This may be accomplished by, whenever an event occurs which changes the size of the container, whether it be the user dragging the borders of the container, or the browser window itself being resized, using JavaScript (e.g., logic 106) to calculate the new size of the container and then set the width & height properties of the image 108 in the document to fit the new container size—unless the image 108 has already been manually zoomed in, in which case the image 108 may not be resized until the user clicks the Fit button.

In one embodiment, logic 106 may enable asynchronous HTTP submission—submission of data via HTTP not requiring the originating webpage to refresh its contents or be redirected to another location. If a relevant response is generated from the processing of the submission, the originating webpage (or any other related webpage) can be updated programmatically without need for fully refreshing its contents or being redirected to another location.

In another embodiment, logic 106 may facilitate in situ “WYSIWYG” editing. Images 108 can be annotated with editable text areas (using, for example, mechanisms described below) allowing the user to add format and style to their text input and having that style and formatting be reflected immediately in the text area.

In one embodiment, network resource 104/logic 106 may enable tabs-based content display with panels for text, images, and thumbnails (see, for example, FIG. 4). The content of a viewport may be controlled by the clicking of various labeled tabs, each tab presenting associated content. The content can be forms, which can be submitted either synchronously or asynchronously. An additional tab/button can submit all tabs/form content in a predefined order. Text can reside in one tab, with images 108 residing in a separate tab, and thumbnails in a third tab. Clicking the thumbnails may bring the image 108 into the image tab.

In some embodiments, logic 106 may enable annotated image swapping or toggling display of layers. The image swapping may include in situ client-side swapping of images 108 controlled by a hyperlink or button, e.g., replacement of an image 108 with a similar image 108, highlighting important/relevant information or changes. Alternatively, a button can turn on or off transparent layers, such as the below described annotation layers.

In various embodiments, the above-described interactive viewing may comprise adjusting by the user, a setting associated with one or more of images 108. In response, logic 106 may request from the server 112 updating of the images 108 with the additional ones of the images 116 based on the adjusted setting. For example, explicit (arbitrary or context-dependent) or implicit (referring to context-dependent parameters) window/level or brightness/contrast setting(s) for an image/image set may be selected and submitted asynchronously to a remote imaging service (e.g., server 112). The images may be returned asynchronously as available and may replace the respective original image(s) 108 in the image (set).

In some embodiments, logic 106 may provide asynchronous loading and an image set viewer. An image set may be viewed one image 108 at a time and controlled either via GUI widgets and/or mouse or key press events. The images 108 may be loaded asynchronously so that the set can be viewed and manipulated in a partially loaded state (i.e., displaying only those images that have become available).

In various embodiments, the above-described asynchronous retrieving may comprise retrieving metadata along with the additional ones of the images 116. In response, logic 106 may update a visual manifestation of the network resource 104 based on the metadata.

In some embodiments, logic 106 may provide resizable window divisions, such as window divisions that are dynamically resizable via drag-and-drop operations and/or window resizing events. Certain divisions can be deemed to be of fixed size or proportion to another and may only be resized within predefined limits or dynamically calculated contextually-based limits.

In various embodiments, logic 106 may provide a control toolbar overlay, such as a set of controls superimposed over another entity (e.g., image 108) that can be minimized, moved, and/or hidden. Optionally, the controls may be located outside of the boundaries of the entity (image) when maximized and the minimization process may resize the entity (image) and superimpose the controls. The toolbar may have buttons to navigate forward and backward through image collection, buttons to zoom in or out on the image 108, a button to “fit” the image 108 to the window size, a button to view the image 108 in its native dimensions (1:1), and a button to switch to a full screen view of the image 108.

In one embodiment, logic 106 may provide a full screen mode. The client device 102 user can toggle between the image collection and a single image 108 by clicking a button or pressing a key. When viewing the single image 108, it may be enlarged to fill the entire window. Toggling between the two modes may be performed using JavaScript (i.e., logic 106) hiding of panels or divisions, rather than reloading the network resource 104, so the act of going back and forth may be speedy and not require a roundtrip to the server 112.

In various embodiments, the above-described interactive viewing may comprise creating or editing by the user a message associated with the network resource 104. Logic 106 may then asynchronously post the message to the server 112. In one embodiment, the messages can be created and/or edited via a form. The new and updated messages may be displayed immediately.

In some embodiments, logic 106 may enable object highlighting. Objects, such as images 108 or text of network resource 104 of certain criteria can have multimedia effects applied to them when a user positions the cursor within their vicinity, suggesting their relevance/applicability/candidacy/etc. for a particular action/operation. Logic 106 or other logic of client device 102 may attach an event listener to the mouse events for a particular HTML object that triggers the relevant multimedia effect (e.g., adding a colored border around the object or changing the color of the existing border, so as to draw attention to it while the cursor is over it).

In one embodiment, logic 106 may enable hover menus. Such menus may be hidden menus that appear when the cursor is positioned over a particular target that allow various actions to be made either synchronously or asynchronously.

In some embodiments, logic 106 may provide look-ahead data loading. When accessing a member of any set of data, the remainder or any subset of that remainder of the data set can be asynchronously loaded via AJAX techniques by logic 106 to remove access latencies associated with on-demand data loading. An example of this would be asynchronously pre-loading the remainder of search results for instant access when accessing any particular search result in a result set or asynchronously pre-loading the images 108 of a file regardless of how many images can be viewed simultaneously.

In various embodiments, logic 106 may provide an integrated stack viewer. If an image 108 belongs to a sequence of images 108 (either time based or spatially), the images 108 in the series may be available to replace the currently displayed image 108, either as an animation or controlled by the user via a scrollbar or mouse wheel. This may be accomplished by logic 106 by pre-loading (e.g., by means described above) the images 108 of the series and by providing a set of widgets (buttons, hyperlinks, sliders, etc). Logic 106 may then detect key press and mouse events and control the currently displayed image 108, simply replacing the SRC attribute of the image 108 with the URL of the replacement image. The pre-loading scheme combined with an in-memory buffering system wherein references to JavaScript Image instances (referring to the URLs of the images in the series) are created and maintained may ensure that the replacement of images will be of minimal latency.

In some embodiments, logic 106 may provide a printer-friendly mode. A content object of resource 104 may have a display mode optimized for printing, either outputting a PDF file or a plain HTML file with printer-friendly dimensions. The printer-friendly display may be constructed using any combination of CSS media selectors, XSLT transformations, (D)HTML markup and JavaScript scripting.

In one embodiment, logic 106 may facilitate resizing of images 108 by dragging on any image 108 (including thumbnails of images 108) to grow or shrink the image size. If the image 108 is a member of a collection that is displayed (such as thumbnail renderings of the images 108 of a case), all members of that collection can be resized to the dimensions of the manipulated image 108, either dynamically or upon completion of the resizing operation on the manipulated image.

In some embodiments, logic 106 may facilitate dynamic translation and rotation of arbitrary images 108 in browser. Before the image 108 is loaded into the browser, logic 114 of server 112 may generate copies of the image 108 for rotation on the backend which are cached into the browser at the client device 102. When a user moves the mouse in a relative motion from an origin established by clicking on the network resource 104, the coordinates of the image 108 may be translated and rotated relative to that origin. Rotation may be handled by converting the degree of rotation into a new image locator which is then displayed while the previous image 108 is hidden. Translation may be handled by moving the image 108 on the resource 104 using CSS styles.

In one embodiment, logic 106 may embed a dynamic application on a network resource 104 without plug-ins. Such an application may be loaded when the resource 104 is loaded into an iframe that is hidden. When the application is requested, the scrolled and absolute offsets may be calculated and the application may be positioned higher than all other elements on the resource 104. A semi-transparent background may be placed beneath the application to prevent users' access to the resource 104 while the application is active. The process may be reversed to minimize or close the application.

In various embodiments, as described above, logic 106 may facilitate drawing graphical primitives at an arbitrary point on network resource 104. Such a graphical primitive may include text, circles, lines, etc. In one embodiment, logic 106 may maintain the state of the graphical primitive choice. When a reference box is established by dragging the mouse across the resource 104 relative to an originating mouse-down event an by receiving a mouse-up event, logic 106 may make an asynchronous request to the server 112 for a primitive corresponding to the selected state. The asynchronous request may contain bounding information for the target reference box, including color, border, and/or size. When the request returns from the server 112, a new draggable, scalable box may be created on the resource 104 containing the image of the primitive rendered from the server 112. The original reference box may then be hidden. In one embodiment, scaling may be accomplished by positioning a small marker element on top of the element that is intended to be scaled with an index higher than the original element. When mouse movement occurs on this marker element after a mouse-down event is fired, the corresponding top element may be resized dynamically following the mouse until a mouse-up event.

In some embodiments, the above-described creating the of the annotation layer may includes creating a container element on the resource 104 having the received graphic primitive and updating a user-interactive list of container elements to include the created container element, the list enabling hiding or showing of graphical primitives. In one embodiment, when a user selects a container on the list, the associated container can then be decorated to indicate selection. Also containers can be hidden or shown dynamically, or removed from the page completely.

In various embodiments, logic 106 may further asynchronously requesting from the server 112 that an annotation layer be anchored or collapsed, the requesting including providing the annotation layer to the server 112 to enable the server to save the annotation layer and any other provided layers to a medical image 116 of the network resource 104. The layers may be sent in a JSON format. Logic 106 may then receive from the server 112 the medical image 108 updated with the annotation layers. In one embodiment, this may be accomplished through a resource locator for that image 108 being returned to the client device 102, and logic 106 then updating the resource 104 with the annotated image 108.

In some embodiments, logic 106 may enable the saving of annotation layers for future use. Since the layers can be represented in JSON format, the corresponding JavaScript object may be sent to the server 112 during the save. When logic 114 of server 112 receives these objects, each one may be committed to a database for future retrieval with all of the reference information for that object.

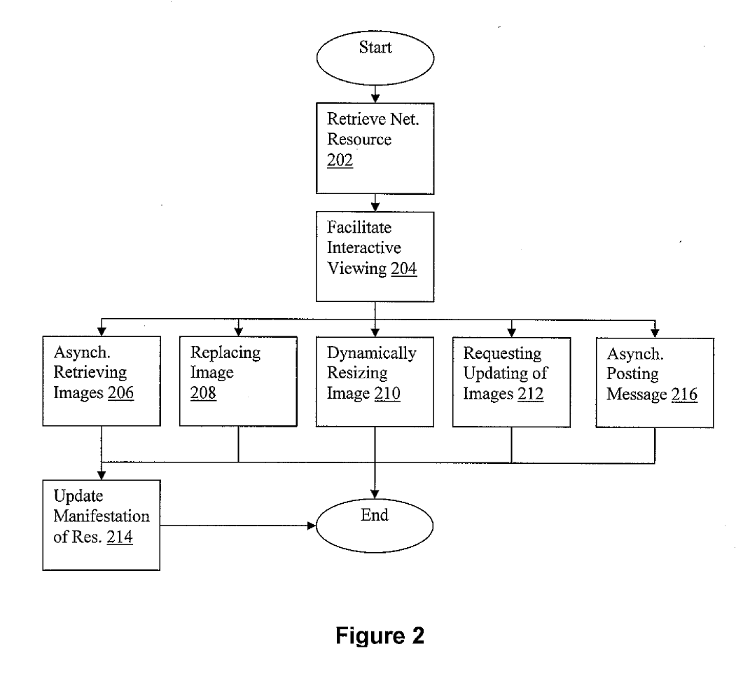

FIG. 2 illustrates a first flowchart view of selected client device operations, in accordance with various embodiments. As illustrated, a client device may retrieve, from a server through a network, a network resource having medical information and associated medical images, block 202, with the server initially including only a subset of the associated images with the retrieved network resource. In one embodiment, the network resource may be a web page including client-side logic, the subset of the associated medical images may be organized as a stack, and the client device may includes a web browser and, optionally, locally available graphics/animation services. In some embodiments, the associated medical images may have been transcoded from a predecessor set of the medical images for efficient transfer over the network, the transcoded medical images having a first image format of a first bit rate lower than a second bit rate of a second image format of the predecessor set.

In various embodiments, the client device may then facilitate interactive viewing of the medical information by a user, including interactive viewing of the associated images, block 204. The facilitating may include asynchronously retrieving, by the client device, additional ones of the associated medical images as the provided medical images are being interactively viewed, block 206. In some embodiments, the interactive viewing may include a user interaction, and the user interaction may be one of a brightness or contrast adjustment, navigation between images of the subset of images, a zooming or panning action, drawing annotations on one of the subset of images, or saving the annotations. In one embodiment, the asynchronous retrieving, block 206, may be in response to the user interaction, and the additional ones of the images retrieved may be selected by the server based on the user interaction.

In some embodiments, the interactive viewing may comprise magnifying one of the subset of images beyond a threshold, the one of the subset of images having a first resolution. The client device may then replace the one of the subset of images with another image having a second resolution, block 208, the first resolution being lower than the second resolution, and the replacing includes asynchronously requesting the other image from server.

In various embodiments, the subset of images may comprise a collection of images, the collection being visually manifested to the user as a set of thumbnail images. Also, the interactive viewing may comprise facilitating the user in browsing to a second collection of images corresponding to the additional ones of the images. Further, the asynchronous retrieving, block 206, may comprise retrieving the second collection.

In some embodiments, the interactive viewing may comprise resizing, by the user, a window containing one of the subset of images, and the one of the subset of images is dynamically resized to fit the resized window dimensions, block 210.

In various embodiments, the interactive viewing may comprise adjusting by the user a setting associated with one or more of the subset of images. The client device may then request of the server updating of the subset of image with the additional ones of the images based on the adjusted setting, block 212.

In some embodiments, the asynchronous retrieving, block 206, may comprise retrieving metadata along with the additional ones of the images. The client device may then update a visual manifestation of the network resource based on the metadata, block 214.

In one embodiment, interactive viewing may comprise creating or editing by the user a message associated with the network resource. The client device may then asynchronously post the message to the server, block 216.

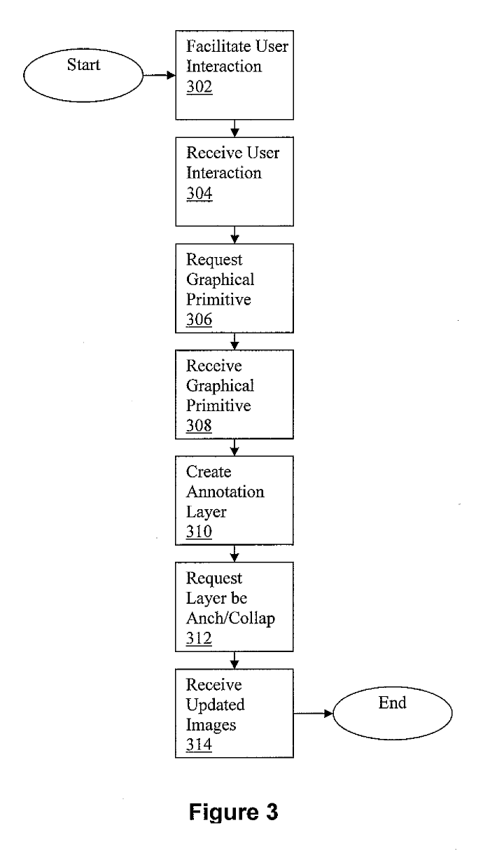

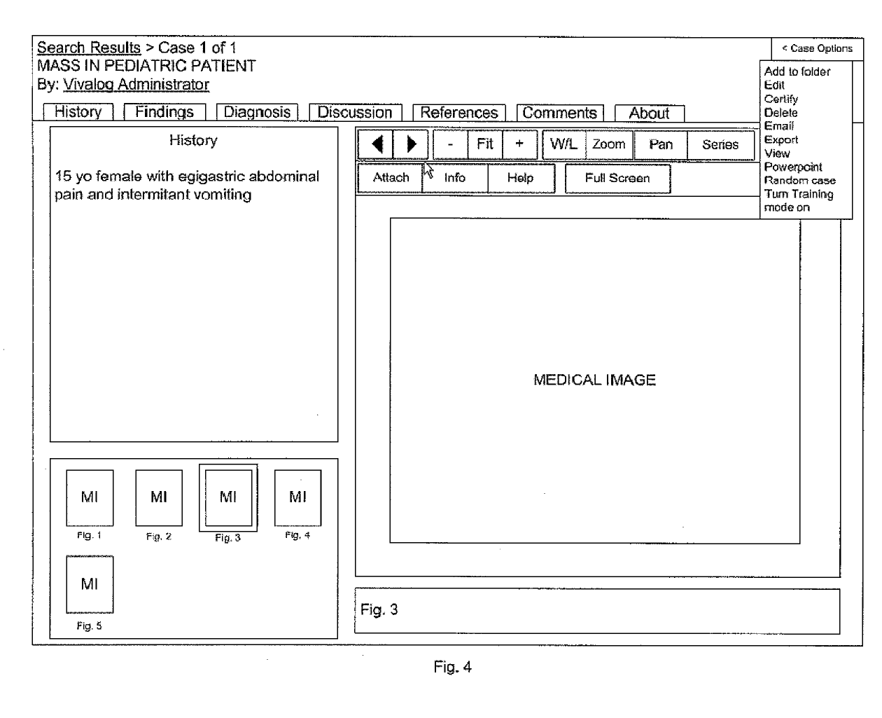

FIG. 3 illustrates a second flowchart view of selected client device operations, in accordance with various embodiments. As illustrated, a client device may facilitate a user interaction with a visually manifested image of a network resource, block 302, the network resource including client-side logic for managing user interactions. The client device may then receive a user interaction, block 304. In response to receiving the user interaction, the client device may asynchronously request of a server a graphical primitive, block 306, the request specifying a graphical primitive type and information associated with the received user interaction. In one embodiment, the graphical primitive may be a draggable, scalable image and the network resource is a web page. The graphical primitive type may be one of a text type, a circle type, a box type, and a line type. In some embodiments, the client device may then receive the graphical primitive, block 308. In response to receiving the graphical primitive, the client device may create an annotation layer including the graphical primitive, block 310. In one embodiment, creating the annotation layer, block 310, may include creating a container element including the received graphic primitive and updating a user-interactive list of container elements to include the created container element, the list enabling hiding or showing of graphical primitives.

In various embodiments, the client device may asynchronously request of the server that the annotation layer be anchored or collapsed, block 312, the request including the annotation layer to enable the server to save the annotation layer and any other provided layers to a medical image of the network resource. The client device may then receive from the server the medical image updated with the annotation layer, block 314.

FIG. 4 illustrates an exemplary screen shot of a case viewer with image viewer on the right. As illustrated, the image viewer on the right may display one of the above-discussed images 108. Also, as shown, the case viewer may include display areas dedicated to displaying the above-described medical information (such as the displayed “Findings”), a collection of thumbnails of images 108, graphic controls to enable the above-described interactive viewing, and a series of tabs to enable the tab-based content display discussed above.

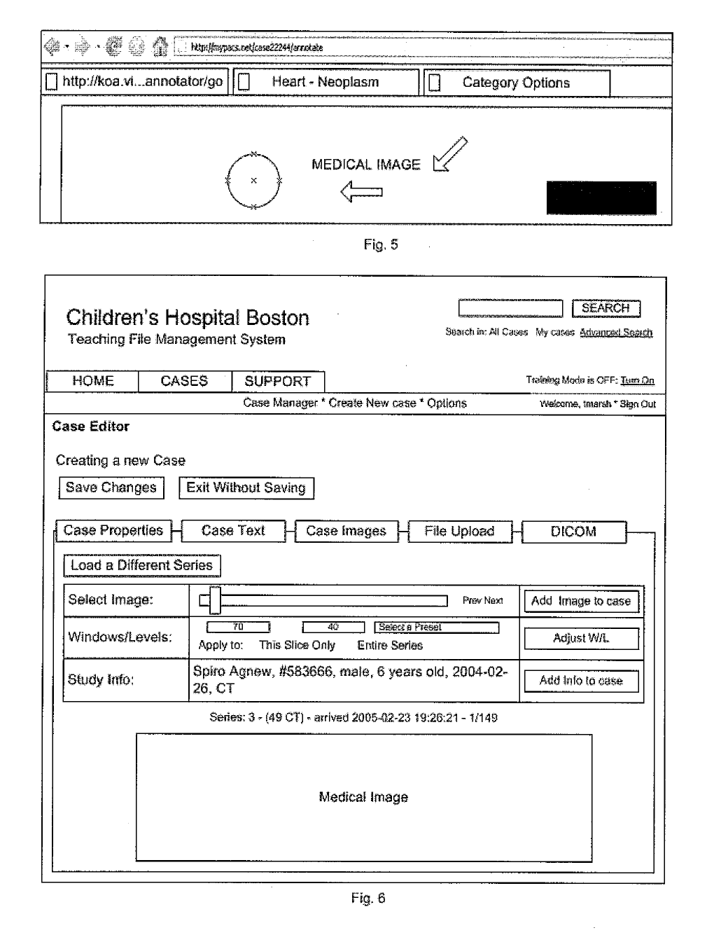

FIG. 5 illustrates an exemplary screen shot of an annotation interface. As illustrated, an image 108 may be visually manifested to a client device 102 user to enable the user to create annotations, including the above-described graphical primitives, to be overlaid in front of the image 108. As shown, the graphical primitives may be, for example, circles, arrows, and boxes of varying colors, dimensions, and transparencies.

FIG. 6 illustrates an exemplary screen shot of a stack viewer. As illustrated, network resource 104 may include one of images 108 and further includes graphical controls to facilitate a user in interactively viewing the images 108, the images 108 organized as a stack to be browsed through.

FIG. 7 illustrates an example computing system suitable for practicing all or selected aspects of the embodiments of the invention. As illustrated, in some embodiments, a computing device 700 may include elements found in conventional computing device, such as micro-controller/processor 702, digital signal processor (DSP) 704, non-volatile memory 706, display 708, input keys 710 (such as 12 key pad, select button, D-unit), and transmit/receive (TX/RX) 712, coupled to each other via bus 714, which may be a single bus or an hierarchy of bridged buses. Further, non-volatile memory 706 may include operating logic 720 adapted to implement the earlier described operations for practicing the methods of the various embodiments of the present invention, such as logic 106 and/or logic 114, in full or in part. The implementation may be via any one of a number programming languages, assembly, C, and so forth.

The permanent copy of the programming instructions may be placed into non-volatile memory 706 in the factory, or in the field, through, for example, a distribution medium (not shown), such as a compact disc (CD), or through TX/RX 712.

In alternate embodiments, all or portions of the embodiments may be implemented in hardware, firmware, or combination thereof. Hardware implementations may be in the form of application specific integrated circuit (ASIC), reconfigured reconfigurable circuits (such as Field Programming Field Array (FPGA)), and so forth.

The constitution of these elements 702-714 are known (except for logic and data associated with network resource 104, logic 106, images 108, logic 114, and images 116), and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
retrieving, by a client device, from a server through a network, a network resource having medical information and associated medical images, with the server initially including only a subset of the associated medical images with the retrieved network resource; and
facilitating, by the client device, interactive viewing of the medical information by a user, including interactive viewing of the associated medical images, including asynchronously retrieving by the client device additional ones of the associated medical images as the provided medical images are being interactively viewed.

2. The method of claim 1, wherein the network resource is a web page including client-side logic and the subset of the associated medical images are organized as a stack.

3. The method of claim 1, wherein the client device includes a web browser, the web browser having at least one of a general purpose scripting language interpreter or locally available general purpose graphics/animation services, and the method further comprises controlling the medical images using the general purpose language interpreter or services, or both.

4. The method of claim 3, wherein the interactive viewing includes a user interaction, and the user interaction is one of a brightness or contrast adjustment, navigation between images of the subset of images, a zooming or panning action, drawing annotations on one of the subset of images, or saving the annotations.

5. The method of claim 4, the asynchronous retrieving is in response to the user interaction, and the additional ones of the images retrieved are selected by the server based on the user interaction.

6. The method of claim 3, wherein the associated medical images having been transcoded from a predecessor set of the medical images for efficient transfer over the network, the transcoded medical images having a first image format of a first bit rate lower than a second bit rate of a second image format of the predecessor set.

7. The method of claim 3, wherein the interactive viewing comprises magnifying one of the subset of images beyond a threshold, the one of the subset of images having a first resolution, and the method further comprises replacing, by the client device, the one of the subset of images with another image having a second resolution, the first resolution being lower than the second resolution, and the replacing includes asynchronously requesting the other image from server.

8. The method of claim 3, wherein
the subset of images comprises a collection of images, the collection being visually manifested to the user as a set of thumbnail images,
the interactive viewing comprises facilitating the user in browsing to a second collection of images corresponding to the additional ones of the images, and
the asynchronous retrieving comprises retrieving the second collection.

9. The method of claim 3, wherein the interactive viewing comprises resizing, by the user, a window containing one of the subset of images, and the one of the subset of images is dynamically resized to fit the resized window dimensions.

10. The method of claim 3, wherein the interactive viewing comprises adjusting by the user, a setting associated with one or more of the subset of images, and the method further comprises requesting of the server, by the client device, updating of the subset of image with the additional ones of the images based on the adjusted setting.

11. The method of claim 3, wherein the asynchronous retrieving comprises retrieving metadata along with the additional ones of the images, and the method further comprises updating, by the client device, a visual manifestation of the network resource based on the metadata.

12. The method of claim 3, wherein the interactive viewing comprises creating or editing by the user a message associated with the network resource, and the method further comprises asynchronously posting the message to the server.

13. A server comprising:
a processor; and
logic to be operated by the processor to
provide to a client device a network resource having medical information and a subset of associated medical images, the network resource including client-side logic to facilitate interactive viewing of the medical information by a user of the client device,
receive from the client device an asynchronous request for additional ones of the associated medical images, the request including at least one parameter associated with the interactive viewing, and
in response to said receive, provide the additional ones of the associated medical images to the client device, the additional ones of the associated medical images being selected in view of the at least one parameter.

14. The server of claim 13, wherein the network resource is a web page, the subset of the associated medical images are organized as a stack, and the client device includes a web browser, the web browser having at least one of a general purpose scripting language interpreter or locally available general purpose graphics/animation services, and the medical images are configured to be controllable using the general purpose language interpreter or service, or both.

15. The server of claim 14, wherein the logic is further to transcode the associated medical images from a predecessor set of the medical images for efficient transfer over the network, the transcoded medical images having a first image format of a first bit rate lower than a second bit rate of a second image format of the predecessor set.

16. The server of claim 14, wherein the parameter is associated with the interactive viewing, the interactive viewing including a user interaction, and the user interaction is one of a brightness or contrast adjustment, navigation between images of the subset of images, a zooming or panning action, drawing annotations on one of the subset of images, or saving the annotations.

17. The server of claim 16, wherein the logic is further to select the additional ones of the images in view of the parameter.

18. An article of manufacture comprising:
a storage medium; and
a plurality of programming instructions stored on the storage medium and configured to enable a client device to
retrieve from a server, through a network, a network resource having medical information and associated medical images, with the server initially including only a subset of the associated medical images with the retrieved network resource, and
facilitate interactive viewing of the medical information by a user, including interactive viewing of the associated medical images, including asynchronously retrieving by the client device additional ones of the associated medical images as the provided medical images are being interactively viewed.

19. The article of claim 18, wherein
the interactive viewing includes a user interaction, and the user interaction is one of a brightness or contrast adjustment, navigation between images of the subset of images, a zooming or panning action, drawing annotations on one of the subset of images, or saving the annotations, and
the asynchronous retrieving is in response to the user interaction.

20. A method comprising:
facilitating, by a client device, a user interaction with a visually manifested medical image of a network resource, the network resource including client-side logic for managing user interactions;
receiving, by the client device, a user interaction;
in response to receiving the user interaction, asynchronously requesting to a server, by the client device, a graphical primitive, the request specifying a graphical primitive type and information associated with the received user interaction;
receiving, by the client device, the graphical primitive; and
in response to receiving the graphical primitive, creating, by the client device, an annotation layer including the graphical primitive, and associating the annotation layer with the medical image.

21. The method of claim 20, wherein the graphical primitive type is one of a text type, a circle type, a box type, and a line type.

22. The method of claim 20, wherein the graphical primitive is a draggable, scalable image and the network resource is a web page.

23. The method of claim 20, wherein creating the annotation layer includes creating a container element including the received graphic primitive and updating a user-interactive list of container elements to include the created container element, the list enabling hiding or showing of graphical primitives.

24. The method of claim 20, further comprising:
asynchronously requesting, by the client device, to the server that the annotation layer be anchored or collapsed, the requesting including providing the annotation layer to the server to enable the server to save the annotation layer and any other provided layers to a medical image of the network resource; and
receiving, by the client device, from the server, the medical image updated with the annotation layer.
